(19) United States
(12) Patent Application Publication
(10) Pub. No.: US 2010/0017537 A1
(43) Pub. Date: Jan. 21, 2010

(54) METHOD OF SELECTING NODES

(75) Inventors: Johan Paul Marie Gerard Linnartz, Eindhoven (NL); Xiangyu Wang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkljke Philips Electronics N.V., Eindhoven (NL)

(21) Appl. No.: 12/439,025

(22) PCT Filed: Sep. 3, 2007
(86) PCT No.: PCT/IB07/53533

§ 371 Date: Feb. 26, 2009

(30) Foreign Application Priority Data
Sep. 8, 2006 (EP) 06120343.6

(51) Int. Cl. G06F 15/173

(52) U.S. Cl. 709/241

(57) ABSTRACT

There is provided a method (700, 900) of selecting nodes (120, 130, 140) in a communication network (100), in which a source node (110) communicates with destination nodes (120, 130, 140). The method (700, 900) includes steps of: (a) transmitting a first message (770, 950) from the source node (100) to the destination nodes (120, 130, 140); (b) receiving response messages (780, 960, 980, 990) at the source node (110) from one or more of the destination nodes (120, 130, 140); (c) in an event of contention arising between the response messages (780, 960, 980, 990) received at the source node (110), iteratively selecting a sub-set (510, 520, 610, 620) of the destination nodes (120, 130, 140) to resend their response messages for receipt at the source node (110) until the response messages are received at the source node (110) without contention, the response messages received without contention being indicative of a suitable destination node having been selected. The method is executable in a communication network (100) for rendering the network (100) more reliable with enhanced quality-of-service (QoS).

### FIELD OF THE INVENTION

The present invention relates to methods of selecting nodes in communication networks, for example in wireless networks. Moreover, the present invention also concerns nodal networks operable to function pursuant to such methods. Furthermore, the invention additionally relates to software products executable on computing hardware for implementing the methods.

### BACKGROUND OF THE INVENTION

Providing reliable communication, namely providing reliable quality of service (QoS), in networks utilizing shared media, for example as in wireless communication networks, is known to be problematical. Unlike corresponding wired counterparts, wireless communication systems are prone to suffering propagation effects such as path loss, shadowing and fading. Moreover, such effects are one or more of location-dependent and time-variant. These effects render the design of wireless systems for time-critical applications, for example audio/video streaming and conferencing, extremely challenging.

It is known that more reliable communication is achievable in wireless networks by exploiting diversity therein. For example, reliability of communication in a wireless network comprising a sender node and a plurality of cooperative nodes is susceptible to being enhanced by selecting a cooperative node in the network which is capable of proving a best instantaneous communication channel for data communication from the sender node. However, in order to provide a satisfactory desired operating characteristic for such a network, it is important that selection of the cooperative node for providing the best instantaneous communication channel is executed very quickly to avoid intolerable communication overheads from occurring.

Diversity in a wireless network arises on account of a transmitter of the network being operable to transmit not only to intended receivers, but also to neighboring receivers thereto. Wireless channels established within the wireless network have communication properties, which are location-variant and time-variant in a substantially uncorrelated manner.

In communication systems exploiting shared communication media such as wireless, a virtual cellular network (VCN) has been proposed as reported in a first scientific publication “Virtual Cellular Network: A New Wireless Communication Architecture with Multiple Access Ports”, pp. 287-307, vol. 10, no. 3, Wireless Personal Communications, 1999. The VCN is distinguished from conventional wireless local area networks (WLAN) in that VCN utilizes multiple cooperative access points (APs) for receiving transmission from a single mobile station. In VCN, as communication paths from the mobile station to the multiple APs are independent, spatial diversity is susceptible to being dynamically applied on a per packet basis to improve robustness of uplink transmissions. However, to enable the APs to receive uplink transmissions cooperatively, various protocols have been proposed. A key challenge arising when applying VCN whilst conforming to IEEE 802.11 standards concerns timely selection of cooperative APs and corresponding timely acknowledgement to sending mobile stations.

In a second scientific publication “Geographical Random Forwarding (GeRaF) for Ad Hoc and Sensor Networks: Energy and Latency Performance” Michele Zorzi and Ramesh Roa, pp. 349-351, IEEE Transactions on Mobile Computing, vol. 2, no. 4, October-December 2003, there are described sensor networks and ad hoc networks which rely on:

(a) sensor nodes which are capable of determining their spatial location; and
(b) positions of a transmitting node and a final destination for a message sent from the transmitting node being explicitly included in the message.

In such networks described, a node which receives a message, namely “hears” a message, is capable of assessing its own priority in acting as a relay for that message. Moreover, all nodes which receive a message in such networks are optionally operable to act as relays for the message in response to their own priority. Such a manner of operation results in best spatially-positioned nodes operating as message relays. Additionally, on account of a posteriori selection of the nodes operating as relays, topological information or routing tables are not needed at each node on account of nodal positional information being sufficient. Geographical routing in such networks enables nodes to be activated and deactivated without coordination; moreover, routing, MAC and topology management are susceptible to being integrated into a single control layer pertaining to such networks.

In networks described in the aforesaid second scientific paper, when a given deactivated node is required to send a data packet, the given node is first activated and proceeds to monitor transmissions at two carrier frequencies for a period. When the given node identifies that transmissions are occurring at either of the two carrier frequencies, namely either frequency is “busy”, the given node backs off and reschedules an attempt to transmit the data packet at a later time. Conversely, when the given node identifies that no transmissions are occurring at both carrier frequencies during the period, the given node transmits a request-to-send (RTS) message and then proceeds to listen in subsequent time slots for a clear-to-send (CTS) message from potential relay nodes in communication proximity to the given node. In each CTS slot following an end of the RTS message, the given node then executes steps as follows:

(a) if only one CTS message is received at the given node, the given node starts transmission of the data packet whose initial part acts as a CTS confirmation for the relay node which issued the CTS message;
(b) if no CTS messages are received at the given node, the given node transmits a continue message and then listens for CTS messages, subject to timing out after Np empty CTS time slots; or
(c ) if a signal is heard by the given node which is not a meaningful message, a message collision is assumed to have occurred and the given node is then operable to send a collision message for invoking a collision resolution algorithm; thereafter the given node listens again for CTS messages.

After transmission of the data packet from the given node, the given node expects to receive an immediate acknowledgement (ACK) message. When such an ACK message is received, the given node assumes that message transmission has been successfully achieved and the given node then reassumes its deactivated state.

Known wireless communication networks elucidated in the foregoing share a design principle of avoiding message collisions as much as possible amongst cooperative nodes when resolving contention between cooperative nodes and selection of a preferred node to acknowledge reception of a data message and to forward the data message. Such a design principle has a disadvantage that these known networks suffer considerable overheads which results in difficulties providing adequate reliability of communication, namely aforementioned QoS.

### SUMMARY OF THE INVENTION

An object of the present invention is to provide a method of selecting nodes in nodal communication networks which resolves contention between nodes of the networks with less degradation to quality of service (QoS).

According to a first aspect of the invention, there is provided a method of selecting nodes in a multi-nodal communication network in which a source node is operable to communicate with a plurality of destination nodes, the method including steps of:

(a) transmitting a first message from the source node to the destination nodes;
(b) receiving one or more response messages at the source node from one or more of the destination nodes;
(c) in an event of contention arising between the one or more response messages received at the source node, iteratively selecting a sub-set of the plurality of destination nodes to resend their one or more response messages for receipt at the source node until the one or more response messages are received at the source node without contention, the one or more response messages received without contention being indicative of a suitable destination node having been selected.

The present invention is of advantage in that contention arising in operation between nodes of the communication network is capable of being more effectively resolved by suitably selecting nodes.

Optionally, step (c) of the method involves iteratively selecting a progressively diminishing sub-set of the plurality of destination nodes by way of a tree-splitting process, the progressively diminishing sub-set of the plurality of destination nodes converging towards the selected suitable destination node. Such progressively diminishing selection is susceptible to iterating towards most suitable destination nodes as well as reducing a number of destination nodes involved which can potentially cause contention. The diminishing selection is beneficially achieved by way of a tree-splitting algorithm synergistically combined with capture effect being employed for selecting nodes for the algorithm.

Optionally, step (c) of the method involves applying a capture process to iteratively select the sub-set of the plurality of destination nodes, the capture process being responsive to a measure of signal power of at least one of: the first message received at the plurality of destination nodes, the one or more response messages received at the source node. The capture process is capable of removing nodes which are less suitable for conveying data messages received from the source node, thereby resulting in fewer destination nodes which are potentially operable to cause message contention.

More optionally, in the method, the capture process involves a step of transmitting one or more messages from the source node to the one or more destination nodes, the one or more messages including information regarding received message power. Received message power is a useful measure for use in implementing the aforementioned capture process for selecting more suitable destination nodes.

More optionally, in the method, the capture process includes a step of comparing the measure of signal power with one or more threshold power parameters at one or more of the plurality of destination nodes. Use of the one or more threshold power parameters provides a convenient binary selection process for selecting more suitable destination nodes.

More optionally, in the method, the one or more threshold power parameters are susceptible to being modified in response to one or more messages transmitted from the source node to one or more of the plurality of destination nodes. The method is thereby potentially capable of accounting for operating conditions with regard to the source nodes as well as destination nodes, thereby providing a more appropriate sub-set of destination nodes.

Optionally, in the method, the first message is a request-to-send message and the one or more response messages are clear-to-send messages, wherein the method includes further steps of:

(d) in response to contention being resolved in step (c) and the suitable destination node being selected, transmitting a data message from the source node to the suitable destination node and subsequently receiving at the source node a corresponding acknowledgement message transmitted from the suitable destination node.

Optionally, in the method, the first message is a data message and the one or more response messages are acknowledgement messages.

According to a second aspect of the invention, there is provided a nodal communication network including a source node and a plurality of destination nodes operable to communicate messages there between, wherein the source node and the plurality of destination nodes are operable to function pursuant to a method pursuant to the first aspect of the invention.

According to a third aspect of the invention, there is provided a communication node including computing hardware operable to execute software for assisting in implementing a method pursuant to the first aspect of the invention.

According to a fourth aspect of the invention, there is provided a software product on a data carrier, wherein the software product when executed upon computing hardware is operable to assist in implementing a method pursuant to the first aspect of the invention.

It will be appreciated that features of the invention are susceptible to being combined in any combination without departing from the scope of the invention as defined by the accompany claims.

### BRIEF DESCRIPTION OF THE DRAWINGS

Embodiments of the present invention will now be described, by way of example only, with reference to the accompanying drawings wherein:

FIG. 1 is an illustration of a simple communication network operable pursuant to the present invention;

FIG. 2 are illustrations of message exchanges in a simple network for elucidating a method of communication pursuant to the present invention;

FIG. 3 is an illustration of a pre-selection method pursuant to the present invention wherein a capture effect is utilized to supplement a tree-splitting algorithm for achieving data communication pursuant to a method of the present invention; and

FIG. 4 is an illustration of a post-selection method pursuant to the present invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF THE EMBODIMENTS

In overview, the present invention concerns multi-node communication networks involving nodes operable to function as source nodes for data or as cooperating nodes to receive such data. When the nodes are not synchronized regarding when they exchange messages, a risk of message collisions can occur. In order to address such collisions, the present invention exploits splitting tree-based algorithms which are operable to efficiently resolve collisions. Splitting tree-based algorithms function by allowing collisions to occur within such networks and then proceeding to solve the collisions by way of feedback indicative of whether idling, successful communication or further collisions have occurred.

In principle, a network N includes a set of transmitters Tₗ to Tₙ wherein a subscript n is an integer greater than unity. The transmitters Tₗ to Tₙ are operable to mutually contend for a receiver R; initially, all of the transmitters Tₗ to Tₙ send a first message M to the receiver R such that temporal message collisions will occur. The receiver R responds by providing feedback to the transmitters Tₗ to Tₙ indicative that collisions have occurred; such feedback can include an absence of any feedback signal for example. In response to such feedback, each transmitter Tₗ to Tₙ then individually computes randomly whether or not to resend their first message M to the receiver R; hence, the set of transmitters Tₗ to Tₙ will thereby split into two groups, namely a primary first group G_{1,1} of transmitters Tₗ to Tₖ operable to retransmit their first messages M and a primary second group G_{1,2} of transmitters Tₖ₊ₗ to Tₙ operable to decline retransmission of their first messages M. The primary first group G_{1,1} of transmitters Tₗ to Tₖ then proceeds to retransmit their first messages M to the receiver R. If no message collisions occur, the receiver R establishes thereby a communication link with a most prompt or powerful transmitter T in the first group G_{1,1}; conversely, if one or more message collisions occur when the first message M is retransmitted, further splitting of the primary first group G_{1,1} of transmitters Tₗ to Tₖ into two secondary groups occurs by way of aforesaid individual computation, namely a secondary first group G_{2,1} of transmitters Tₗ to Tₘ which is operable to repeat retransmission of the first message M and a secondary second group G_{2,2} of transmitters Tₘ₊ₗ to Tₖ which are operable to repeat retransmission of the first message M. Further splitting in a similar manner can occur if further message collisions are encountered.

The present invention is distinguished from known approaches for coping with message collisions by beneficially permitting some collisions to occur during a pre-phase to selecting nodes and then resolving the collisions using aforesaid splitting-tree algorithms. In other words, RTS messages are intentionally sent to invite subsequent message collisions during a reservation phase wherein there is one source and multiple receivers as destinations. Thus, the present invention utilizes a RTS message that invites CTS responses from multiple nodes and risks message collisions occurring in consequence. Moreover, the present invention is further distinguished in that it additionally employs a form of capture effect to synergistically speed up such tree-splitting algorithms. In conventional networks subject to media access problems, a node which communicates strongly, for example radiates more electromagnetic radiation, is susceptible to capture a disproportionately large amount of media access time. In the present invention, such capture effect characteristics are employed to accelerate operation of the aforementioned tree-splitting algorithm.

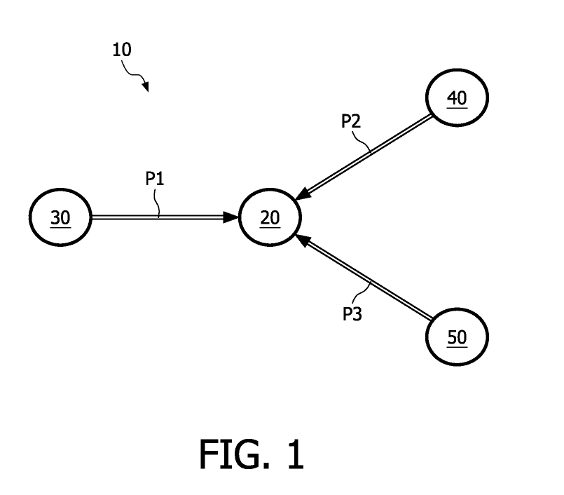

The capture effect will now be further elucidated with reference to FIG. 1. In FIG. 1, a simple wireless network is indicated generally by 10. The network 10 includes a receiver which is denoted by 20 (R), the receiver 20 being operable to capture a signal received thereat if the signal has a magnitude which results in it exceeding a signal-to-interference-noise-ratio (SINR) threshold H pertaining at the receiver 20. Thus, two or more simultaneous transmissions from transmitters 30, 40, 50 (T1, T2, T3) to the receiver 20 (R) do not result in a signal collision occurring at the receiver 20 (R) if a transmission from the transmitter 30 (T1) has a substantially higher power P1 than a summation E(P2+P3) of transmissions from the transmitters 40, 50 (T2, T3) and background noise N as described by Equation 1 (Eq. 1):

$$SINR = \frac{P 1}{E ( P 2 + P 3 ) + N} > H \qquad Eq . 1$$

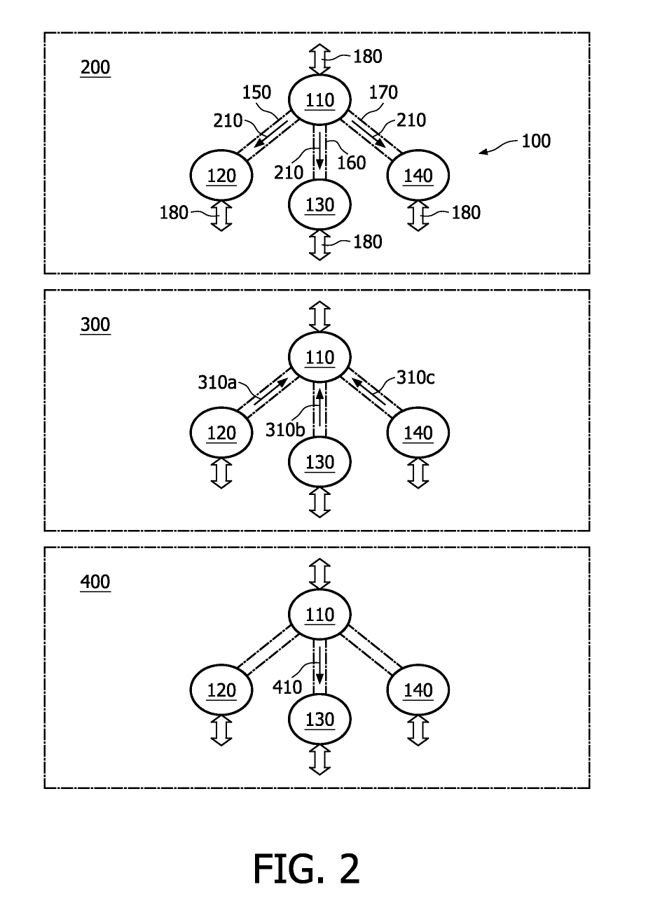

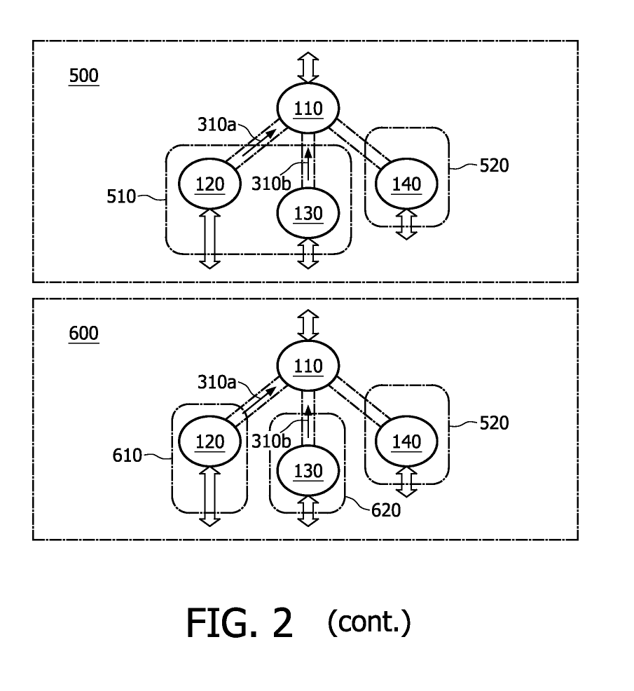

The present invention provides a synergistic combination of aforesaid tree-splitting algorithms and the capture effect as illustrated in FIG. 2 to provide a highly efficient and straightforward method of coping with message collisions in networks where media access is shared, for example as in wireless networks. However, the present invention is not limited to solely wireless networks and can be utilized in other forms of media-shared networks.

Referring to FIG. 2, there is shown a portion of a nodal network indicated generally by 100. The network 100 includes a source node 110 (S) and a plurality of cooperative nodes, for example three cooperative nodes 120, 130, 140 (C1, C2, C3). One or more of the source node 110 and the cooperative nodes 120, 130, 140 (C1, C2, C3) are optionally coupled to other network nodes (not shown) denoted by arrows 180. Moreover, the source node 110 (S) and the cooperative nodes 120, 130, 140 (C1, C2, C3) are mutually coupled together by way of wireless communication links 150, 160, 170, for example radio radiation propagation paths; optionally, such wireless communication links 150, 160, 170 are generally compliant with communications standards such as IEEE 802.11.

Operation of the nodes 110, 120, 130, 140 (S, C1, C2, C3) for communicating data there between will now be described with reference to FIG. 2. In a first step 200, the source node 110 (S) sends a request-to-send (RTS) message 210 in a format suitable for the cooperative nodes 120, 130, 140 (C1, C2, C3) to receive. The RTS message 210 propagates through the communication links 150, 160, 170 to be received at the cooperative nodes 120, 130, 140 (C1, C2, C3) respectively. On account of the cooperative nodes 120, 130, 140 (C1, C2, C3) not being mutually coordinated or otherwise synchronized in operation, each of the cooperative nodes 120, 130, 140 (C1, C2, C3) responds to receipt of the RTS message 210 in a second step 300 by immediately transmitting a clear-to-send messages 310a, 310b, 310c (CTS1, CTS2, CTS3) respectively via the communication links 150, 160, 170 respectively for receipt at the source node 110 (S).

In an event that a given node of the cooperative nodes 120, 130, 140 (C1, C2, C3) is operable to transmit its CTS message 310 over its communication link so that its message 310 is received first and most strongly at the source node 110 (S) in comparison to that of the other cooperative nodes, the given node is captured as elucidated in the foregoing and thereby accepted to be a cooperative node to which the source node 110 (S) has established communication. For example, the cooperative node 130 (C2) responds most strongly and rapidly with its CTS2 message 310b in comparison to the cooperative nodes 120, 140 (C1, C3), resulting in the source node 110 (S) proceeding in a third step 400 to transmit a data packet (DATA) 410 to the cooperative node 130 (C2).

However, in an event that the cooperative nodes 120, 130, 140 (C1, C2, C3) are operable to transmit their CTS1, CTS2, CTS3 messages 310a, 310b, 310c so that they are received substantially simultaneously and with mutually substantially similar strength at the source node 110 (S), a collision of messages occurs, namely contention occurs, with a result that the source node 110 (S) is not able to commence in response to transmit its data packet (DATA) 410. In an absence to subsequent non-receipt of the data packet (DATA) 410 in such a collision at any of the cooperative nodes 120, 130, 140 (C1, C2, C3), each of the cooperative nodes 120, 130, 140 (C1, C2, C3) such absence of receipt if the data packet (DATA) 410 to indicate contention has occurred and then proceeds to compute pursuant to a probability distribution whether or not it should resend its CTS1, CTS2, CTS3 message 310a, 310b, 310c respectively to the source node 110 (S). The cooperative nodes 120, 130, 140 (C1, C2, C3) thereby become subdivided into two groups, namely:

(a) a primary first group 520 of the cooperating nodes 120, 130, 140 (C1, C2, C3) which compute not to retransmit their CTS messages 310, for example the primary first group 520 comprises the cooperative node 140 (C3); and
(b) a primary second group 510 of cooperative nodes 120, 130, 140 (C1, C2, C3) which compute to retransmit their CTS messages 310, for example the primary second group 510 comprises the cooperative nodes 120, 130 (C1, C2).

In a fourth step 500 depicted in FIG. 2, the cooperating nodes 120 130 (C1, C2) of the primary first group 510 each retransmit their CTS1, CTS2 messages 310a, 310b to the source node 110 (S). In an event that one of the cooperative nodes 120, 130 (C1, C2) transmits its CTS message 310 to be received more promptly and considerably more strongly at the source node 110 (S) than other of the cooperative nodes 120, 130 (C1, C2), the source node 110 (S) is able to capture as elucidated in the foregoing with reference to FIG. 1 the more promptly cooperative node of the primary first group 520 which is to receive the data packet (DATA) 410. However, in an event that the cooperative nodes 120, 130 (C1, C2) are operable to transmit their CTS1, CTS2 messages 310a, 310b so that they are received substantially simultaneously and with mutually substantially similar strength at the source node 110 (S), a further collision of messages occurs with a result that the source node 110 (S) is not able to commence in response to transmit its data packet (DATA) 410. In an absence to subsequent non-receipt of the data packet (DATA) 410 in such a collision at the cooperating nodes 120, 130 (C1, C2) of the second group 510, each of the cooperative nodes 120, 130 (C1, C2) then proceeds to compute pursuant to a further probability distribution whether or not it should resend its CTS1, CTS2 message 310a, 310b. The cooperative nodes 120, 130 (C1, C2) thereby become subdivided into two further groups in a step 600, namely:

(a) a secondary first group 610 of the cooperative nodes 120, 130 (C1, C2) which compute not to retransmit their CTS1, CTS2 messages 310a, 310b to the source node 110 (S), for example the secondary first group 610 comprises the cooperative node 120 (C1); and
(b) a secondary second group 620 of cooperating nodes 120, 130 (C1, C2) which compute to retransmit their CTS1, CTS2 messages 310a, 310b to the source node 110 (S), for example the secondary second group 620 comprises the cooperative node 130 (C2). In consequence of subdividing into the secondary groups 610, 620, the cooperative node 130 (C2) is eventually able to capture the source node 110 (S) for purposes of communication. It will be appreciated that more than the example three cooperative nodes 120, 130, 140 (C1, C2, C3) are susceptible to being involved in the network 100 such that the potentially more than primary and secondary groups are involved with communicating with the source node 110 (S). FIG. 2 represents a “splitting tree-based” algorithm for resolving communication conflicts within multi-node communication networks.

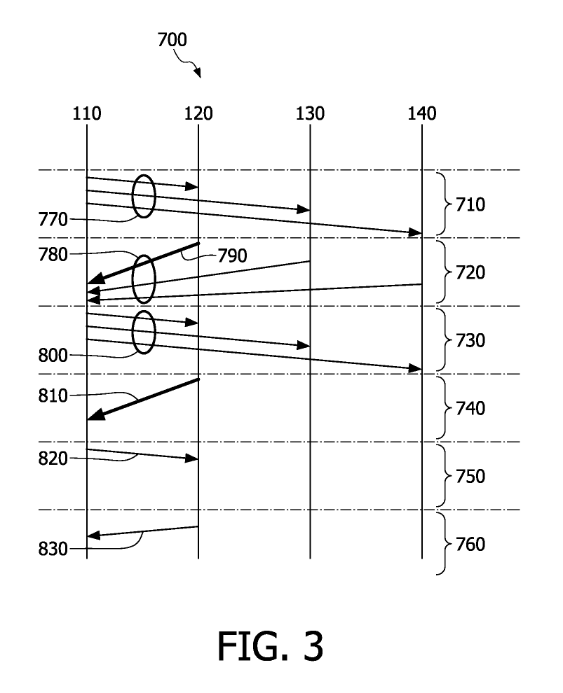

The nodal network 100 and its operation are susceptible to be further enhanced by enabling the cooperative nodes 120, 130, 140 (C1, C2, C3) to effectively determine characteristics of their communication channels 150, 160, 170 respectively to the source 110 (S). Such determination of characteristics is conveniently referred to as the cooperative nodes 120, 130, 140 (C1, C2, C3) “learning” about their communication channels 150, 160, 170 as will now be elucidated with reference to FIG. 3.

Referring to FIG. 3, there is shown a method of selecting nodes illustrated in diagrammatic form and indicated generally by 700. The method 700 comprises a series of steps 710, 720, 730, 740, 750, 760. In the method 700, the source node 110 (S) and the cooperative nodes 120, 130, 140 (C1, C2, C3) are represented by vertical lines. In the method 700, the cooperative nodes 120, 130, 140 (C1, C2, C3) are operable to characterize their communication channels, namely their communication links 150, 160, 170, with the source node 110 (S). An assumption is made that each such channel is reciprocal. Each cooperative node 120, 130, 140 (C1, C2, C3) is operable to measure received power thereat during reception of a first RTS message. Beneficially, each of the cooperative nodes 120, 130, 140 (C1, C2, C3) is configured to apply its threshold power level P_{L}: if the aforesaid measured received power PL at a given cooperative node 120, 130, 140 (C1, C2, C3) is greater than the threshold power level PL for that given cooperative node 120, 130, 140 (C1, C2, C3), the given cooperative node 120, 130, 140 (C1, C2, C3) is operative to subsequently send its CTS message back to the source node 110 (S). Conversely, if the aforesaid measured received power at a given cooperative node 120, 130, 140 (C1, C2, C3) is less than or equal to the threshold power level PL for that given cooperative node 120, 130, 140 (C1, C2, C3), the given cooperative node 120, 130, 140 (C1, C2, C3) is operative to decline sending its CTS message back to the source node 110 (S). Such a manner of cooperative nodal selection based upon received power is applied in the method 700 in combination with the aforesaid tree-splitting algorithm as elucidated in the foregoing with reference to FIG. 2.

Thus, in an event of message collision occurring at the source node 110 (S), the source node 110 (S) is operable to retransmit its RTS message; the source node 110 (S) is also operable to retransmit the RTS message in an event that none of the cooperative nodes 120, 130, 140 (C1, C2, C3) respond to the first RTS message. Such retransmission is required in order for the source node 110 (S) to communicate to the cooperative nodes 120, 130, 140 (C1, C2, C3) pursuant to following scenarios:

(a) the collision has occurred with high receiving power at the source node 110 (S) because threshold power levels PL at the cooperative nodes 120, 130, 140 (C1, C2, C3) were specified to be too low resulting in too many of the cooperative nodes 120, 130, 140 (C1, C2, C3) responding to the first RTS message; or
(b) the source node 110 (S) was operable to transmit the first RTS message with insufficient power so that corresponding received RTS message signal power measured at the cooperative node 120, 130, 140 (C1, C2, C3) was below the threshold power level PL of the cooperative nodes 120, 130, 140 (C1, C2, C3).

In a scenario (a) wherein the threshold power levels PL were specified to be too low, the cooperative nodes 120, 130, 140 (C1, C2, C3) are operable in response to receiving the retransmitted RTS message from the source node 110 (S) to increase their threshold power levels PL and then evaluate, using their increased threshold power levels PL as criteria, whether or not the transmit their RTS message in response back to the source node 110 (S). Conversely, in a scenario (b) wherein none of the cooperative nodes 120, 130, 140 (C1, C2, C3) are responsive to the first RTS message, the cooperative node 120, 130, 140 (C1, C2, C3) are operable to reduce their threshold power levels P_{L} so that more of the cooperative node 120, 130, 140 (C1, C2, C3) are operable to transmit their CTS messages in response to receiving the retransmitted RTS message from the source node 110 (S).

Thus, referring again to FIG. 3, in a step 710 of the method 700, the source node 110 (S) sends its first RTS message denoted by 770 to the three cooperative nodes 120, 130, 140 (C1, C2, C3); each cooperative node 120, 130, 140 (C1, C2, C3) measures power of the first RTS message received thereat and then compares the measured power with its threshold power level P_{L}. In a situation, for example, wherein the measured power exceeds the threshold power levels P_{L} at all of the cooperative nodes 120, 130, 140 (C1, C2, C3), all the cooperative nodes 120, 130, 140 (C1, C2, C3) in a step 720 of the method 700 are operable to send to the source node 110 (S) their CTS messages denoted by 780, wherein the CTS messages bear information indicative of the measured power of the first RTS message 770 received at the cooperative nodes 120, 130, 140 (C1, C2, C3); for example, a CTS message denoted by 790 transmitted from the cooperative node 120 (C1) is indicative that the first RTS message was most strongly receive at the cooperative node 120 (C1). In a step 730 of the method 700, the source node 110 (S) is operable to measure a total power E_{P}received thereat in response to receiving the CTS messages 780; moreover, the source node 110 (S) then proceeds to transmit in its retransmission of the first RTS message denoted by 800 data indicative of the total received power E_{P}. In a step 740 of the method 700, the cooperative nodes 120, 130, 140 (C1, C2, C3) compute a ratio K of its received power regarding reception of the RTS message in comparison to the total power E_{P} and the proceeds to compare the ratio K with its threshold power level L_{P}. In an event that the ratio K for a given cooperative node 120, 130, 140 (C1, C2, C3) is greater than the threshold power level L_{P}, the given cooperative node 120, 130, 140 (C1, C2, C3) responds by sending its CTS message, for example the cooperative node 120 (C1) send its CTS message as denoted by 810, back to the source node 110 (S). In a subsequent step 750 of the method 700, the source node 110 (S) sends a data message denoted by 820 to the cooperative nodes 120, 130, 140 (C1, C2, C3), for example to the cooperative node 120 (C1) which responded in the step 740. In a yet subsequent step 760, the cooperative node 120 (C1) send an acknowledgement message ACK as denoted by 830 back to the source node 110 (S).

When implementing the method 700, the threshold power level L_{P} can be initially configured in all the cooperative nodes 120, 130 140 (C1, C2, C3). Alternatively, the source node 110 (S) is operable to configure the threshold power level L_{P} for the cooperative nodes 120, 130, 140 (C1, C2, C3). Optionally, the cooperative nodes 120, 130, 140 (C1, C2,C3) can be allocated with mutually different threshold power levels L_{P}, namely individualized to the cooperative nodes 120, 130, 140 (C1, C2, C3). Alternatively, optionally, the cooperative nodes 120, 130, 140 (C1, C2, C3) can be allocated with mutually similar threshold power levels L_{P}. For example, an initial threshold power level expressed as a ratio is beneficially 50%. Each cooperative node 120, 130, 140 (C1, C2, C3) is then operative to determine whether or not it needs to subsequently transmit based in the threshold power level L_{P} allotted or assigned to it.

On account of the aforesaid capture effect occurring when implementing the method 700 involving feedback form the source node 110 (S) in terms of absolute power or a power ratio, the method 700 is susceptible to providing technical benefits of fast selection of cooperative nodes 120, 130, 140 (C1, C2, C3) and also ensures that a given one of the cooperative nodes 120, 130, 140 (C1, C2, C3) with best instantaneous channel condition will win contention and be selected for receiving the data message 820.

It will be appreciated that although the present invention is described in an example situation of three cooperative nodes 120, 130, 140 (C1, C2, C3), there can be potentially more than three cooperative nodes as well as potentially less than three cooperative nodes.

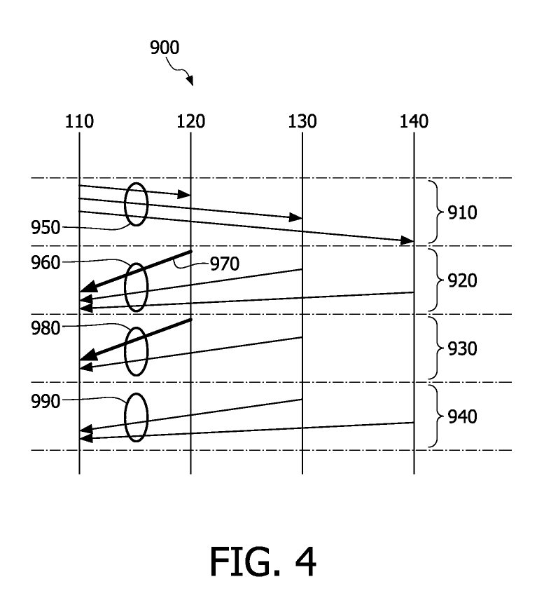

The present invention is also susceptible to being implemented in other ways as will now be described with reference to FIG. 4. The method 700 elucidated in the foregoing employs pre-selection of the cooperative nodes 120, 130, 140 (C1, C2, C3) to select a preferred cooperative node, followed by communication of a data message to that preferred cooperative node with an acknowledge message thereafter therefrom. A method pursuant to the present invention indicated generally by 900 in FIG. 4 concerns post-selection of cooperative nodes as will now be described.

Referring to FIG. 4, the method 900 comprises four steps 910, 920, 930, 940 and involves the nodes 110, 120, 130, 140 (S, C1, C2, C3) as represented by vertical lines in FIG. 4. In a first step 910 of the method 900, the source node 110 (S) transmits a data message denoted by 950 to the cooperative nodes 120, 130, 140 (C1, C2, C3). The cooperative nodes 120, 130, 140 (C1, C2, C3) then mutually contend, for example by way of message exchange therebetween pursuant to power threshold level algorithms as elucidated in the foregoing, and mutually elect one of the cooperative nodes 120, 130, 140 (C1, C2, C3) to respond back by sending an acknowledgement message back to the source node 110 (S) as denoted by 960 in a second step 920 of the method 900, for example the cooperative node 120 (C1) responds back with an acknowledgement message as denoted by 970. Optionally, the source node 110 (S) waits a period of time until all cooperative nodes 120, 130, 140 (C1, C2, C3) that have received the data message respond back with a corresponding acknowledgement message as denoted in steps 930, 940 of the method 900. On account of post-selection being employed in the method 900, for purpose of data message propagation, the source node 110 (S) is only concerned that at least one of the cooperative nodes 120, 130, 140 (C1, C2, C3) has received the data message 950. In the method, whether or not the cooperative nodes 120, 130, 140 (C1, C2, C3) that have send back their acknowledgement message 960, 980, 990 is a best node for supporting communication of the data message is immaterial with regard to successful propagation of the data message 950.

The present invention is susceptible to being used in diverse forms of data communication systems. For example, the present invention is application to virtual cellular networks wherein one-hop communication takes place, for example in wireless computer communication networks. Moreover, for example, the present invention is also relevant to multi-hop ad hoc networks, for example distributed sensor networks. Furthermore, the present invention is also susceptible to being applied to upgrade existing established communication standards such as, for example, IEEE 802.11s and IEEE 802.15.5.

The present invention as elucidated in embodiments described in the foregoing is susceptible to being implemented in one or more software products executable on computing hardware. Moreover, such one or more software products are conveyable on a data carrier such as a signal, memory device, data memory and similar.

Modifications to embodiments of the invention described in the foregoing are possible without departing from the scope of the invention as defined by the accompanying claims.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Numerals included within parentheses in the accompanying claims are intended to assist understanding of the claims and should not be construed in any way to limit subject matter claimed by these claims.

1. A method of selecting nodes in a multi-nodal communication network (100) in which a source node (110) is operable to communicate with a plurality of destination nodes (120, 130, 140), said method including steps of:
(a) transmitting a first message (210, 770, 950) from the source node (110) to the destination nodes (120, 130, 140);
(b) receiving one or more response messages (310, 780, 960) at the source node (110) from one or more of the destination nodes (120, 130, 140);
(c) in an event of contention arising between said one or more response messages (310, 780, 960) received at the source node (110), iteratively selecting a sub-set (510, 520, 610, 620) of said plurality of destination nodes (120, 130, 140) to resend their one or more response messages for receipt at the source node (110) until said one or more response messages are received at the source node (110) without contention, said one or more response messages received without contention being indicative of a suitable destination node having been selected.

2. A method of selecting nodes as claimed in claim 1, wherein step (c) involves iteratively selecting a progressively diminishing sub-set of the plurality of destination nodes by way of a tree-splitting process, said progressively diminishing sub-set of said plurality of destination nodes converging towards said selected suitable destination node.

3. A method of selecting nodes as claimed in claim 2, wherein step (c) involves applying a capture process to iteratively select said sub-set of said plurality of destination nodes, said capture process being responsive to a measure of signal power of at least one of: said first message received at said plurality of destination nodes, said one or more response messages received at said source node ( 110).

4. A method of selecting nodes as claimed in claim 3, wherein said capture process involves a step of transmitting one or more messages from said source node (110) to said one or more destination nodes (120, 130, 140), said one or more messages including information regarding received message power.

5. A method of selecting nodes as claimed in claim 3, wherein said capture process includes a step of comparing said measure of signal power with one or more threshold power parameters at one or more of said plurality of destination nodes (120, 130, 140).

6. A method of selecting nodes as claimed in claim 5, wherein said one or more threshold power parameters are susceptible to being modified in response to one or more messages transmitted from said source node to one or more of said plurality of destination nodes (120, 130, 140).

7. A method of selecting nodes as claimed in claim 1, wherein said first message is a request-to-send message and said one or more response messages are clear-to-send messages, wherein said method includes further steps of:
(d) in response to contention being resolved in step (c) and said suitable destination node being selected, transmitting a data message from said source node to said suitable destination node and subsequently receiving at said source node a corresponding acknowledgement message transmitted from said suitable destination node.

8. A method of selecting nodes as claimed in claim 1, wherein said first message is a data message and said one or more response messages are acknowledgement messages.

9. A nodal communication network including a source node and a plurality of destination nodes, wherein said source node is operable to communicate with a plurality of destination nodes by transmitting a first messagae from the source node to the destination nodes, receiving one or more response messages at the source node from one or more of the destination nodes; in an event of contention arising between said one or more response mnessages received at the source node iteratively selecting a sub-set of said plurality of destination nodes to resend their one or more response messages for receipt at the source node until said one or more response messages are received at the source node without contention, said one or more response messages received without contention being indicative of a suitable destination node having been selected.

10. (canceled)

11. A software product on a data carrier, wherein said software product when executed upon computing hardware, is operable to carry out a method of selecting nodes in a multi-nodal communication network in which a source node is operable to communicate with a plurality of destination nodes by transmitting a first message from the source node to the destination nodes, receiving one or more response messages at the source node from one or more of the destination nodes, in an event of contention arising between said one or more response messages received at the source node, iteratively selecting a sub-set of said plurality of destination nodes to resend their one or more response messages for receipt at the source node until said one or more response messages are received at the source node without contention. said one or more response messages received without contention being indicative of a suitable destination node having been selected.
